(19) United States
(12) Patent Application Publication
(10) Pub. No.: US 2013/0268139 A1
(43) Pub. Date: Oct. 10, 2013

(54) VEHICULAR REMOTE START SYSTEM

(71) Applicant: DENSO CORPORATION, Kariya-city (JP)

(72) Inventor: Kazuhiko Endo, Toyota-city (JP)

(73) Assignee: DENSO CORPORATION, Kariya-city (JP)

(21) Appl. No.: 13/855,137

(22) Filed: Apr. 2, 2013

(30) Foreign Application Priority Data
Apr. 9, 2012 (JP) 2012-088385

(51) Int. Cl. F02N 11/08

(52) U.S. Cl. CPC F02N 11/0807
USPC 701/2

(57) ABSTRACT

A terminal is enabled to receive an input manipulation of an engine start request by a user, and communicates with an in-vehicle apparatus mounted in a host vehicle via a wireless communication network. When the input manipulation of the engine start request is made in the terminal, a server functioning as a determination section determines whether the host vehicle exists in an idling prohibition region. The server also functions as a start permission output section. When the host vehicle does not exist in the idling prohibition region, the server outputs a start permission instruction for an engine start apparatus. When the host vehicle exists in the idling prohibition region, any start permission instruction is not outputted.

### CROSS REFERENCE TO RELATED APPLICATION

The present application is based on Japanese Patent Application No. 2012-88385 filed on Apr. 9, 2012, the disclosure of which is incorporated herein by reference.

### TECHNICAL FIELD

The present disclosure relates to a vehicular remote start system which starts an engine of a vehicle from a remote position using a terminal.

### BACKGROUND ART

[Patent Literature 1] JP 2005-163702 A

Patent Literature 1 discloses a remote engine starter which permits a user to start an engine of a host vehicle for starting a warm-up of the engine before getting in the host vehicle, or starting previously an air conditioner in a compartment of the host vehicle.

In Patent Literature 1, a position detection portion (i.e., navigation apparatus) is provided in the host vehicle for detecting a present position of the host vehicle; the remote engine starter determines that the engine start is inappropriate when the host vehicle is detected to be in a general road or a garage. Some local governments such as prefectures, cities, towns, and villages, have an ordinance or regulation to prohibit a remote engine start, i.e., idling in predetermined regions (which are referred to as idling prohibition regions or idling prohibition ordinance-legislated regions). The above remote engine starter may execute a remote engine start even in an idling prohibition ordinance-legislated region, not complying with the idling prohibition ordinance.

### SUMMARY

It is an object to provide a vehicular remote start system, which detects automatically whether a position of a host vehicle is located in an idling prohibition region, avoiding a remote engine start of the host vehicle in the idling prohibition region. To achieve the above object, according to an aspect of the present disclosure, a vehicular remote start system is provided to include: an in-vehicle apparatus; a terminal; a wireless communication network; a host-vehicle position estimation section; a determination section; and a start permission output section. The in-vehicle apparatus is disposed in a host vehicle including an engine start apparatus that relates to an engine start of the host vehicle. The terminal receives an input manipulation of an engine start request by a user to request of the engine start. The wireless communication network includes a server and a plurality of wireless base stations, to permit a communication between the in-vehicle apparatus and the terminal. The host-vehicle position estimation section estimates a host-vehicle position of the host vehicle. The determination section determines whether the host vehicle exists in an idling prohibition region, which is legislated in a local governmental regulation, from the host-vehicle position estimated by the host-vehicle position estimation section upon receiving the engine start request in the terminal. The start permission output section outputs a start permission instruction to the engine start apparatus when it is determined that the host vehicle does not exist in the idling prohibition region, and does not output the start permission instruction when it is determined that the host vehicle exists in the idling prohibition region.

### BRIEF DESCRIPTION OF THE DRAWINGS

The above and other objects, features, and advantages of the present disclosure will become more apparent from the following detailed description made with reference to the accompanying drawings. In the drawings:

FIG. 1 is a schematic block diagram illustrating a vehicular remote start system according to a first embodiment of the present disclosure;

FIG. 2 is a functional block diagram of an in-vehicle apparatus;

FIG. 3 is a functional block diagram of a terminal;

FIG. 4 is a functional block diagram of a server;

FIG. 5A is a flowchart diagram illustrating an operation of a terminal;

FIG. 5B is a flowchart diagram illustrating an operation of a server;

FIG. 5C is a flowchart diagram illustrating an operation of an in-vehicle apparatus;

FIG. 6 is a functional block diagram of an in-vehicle apparatus according to a second embodiment;

FIG. 7 is a functional block diagram of a server according to the second embodiment;

FIG. 8A is a flowchart diagram illustrating an operation of a terminal according to the second embodiment;

FIG. 8B is a flowchart diagram illustrating an operation of a server according to the second embodiment;

FIG. 8C is a flowchart diagram illustrating an operation of an in-vehicle apparatus according to the second embodiment;

FIG. 9 is a schematic block diagram illustrating a vehicular remote start system according to a third embodiment of the present disclosure;

FIG. 10 is a functional block diagram of an in-vehicle apparatus according to the third embodiment;

FIG. 11 is a functional block diagram of a terminal according to the third embodiment;

FIG. 12 is a functional block diagram of a server according to the third embodiment;

FIG. 13A is a flowchart diagram illustrating an operation of a terminal according to the third embodiment;

FIG. 13B is a flowchart diagram illustrating an operation of a server according to the third embodiment;

FIG. 13C is a flowchart diagram illustrating an operation of an in-vehicle apparatus according to the third embodiment;

FIG. 14 is a schematic block diagram illustrating a vehicular remote start system according to a fourth embodiment of the present disclosure;

FIG. 15A is a flowchart diagram illustrating an operation of a terminal according to a fifth embodiment;

FIG. 15B is a flowchart diagram illustrating an operation of a server according to the fifth embodiment;

FIG. 15C is a flowchart diagram illustrating an operation of an in-vehicle apparatus according to the fifth embodiment;

FIG. 16A is a flowchart diagram illustrating an operation of a terminal according to a sixth embodiment;

FIG. 16B is a flowchart diagram illustrating an operation of a server according to the sixth embodiment; and

FIG. 16C is a flowchart diagram illustrating an operation of an in-vehicle apparatus according to the sixth embodiment.

### DETAILED DESCRIPTION

### First Embodiment

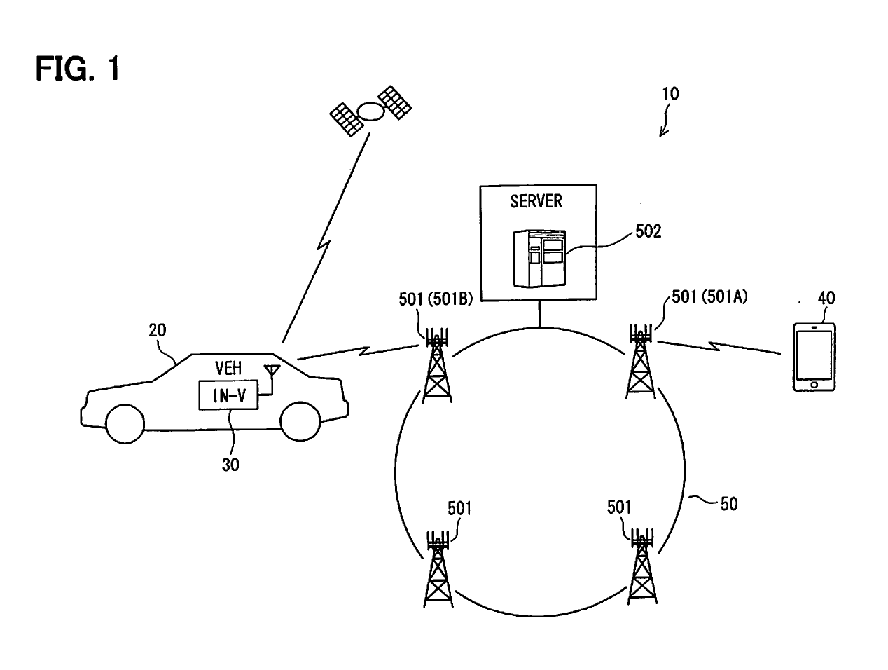

The following will explain a first embodiment of the present disclosure with reference to FIG. 1 to FIG. 5C. A vehicular remote start system 10 includes an in-vehicle apparatus 30 disposed in a host vehicle 20 (also referred to as a subject vehicle); a terminal 40 manipulated by a user; and a wireless communication network 50 which permits the in-vehicle apparatus 30 and the terminal 40 to communicate wirelessly (to perform a wireless communication) with each other.

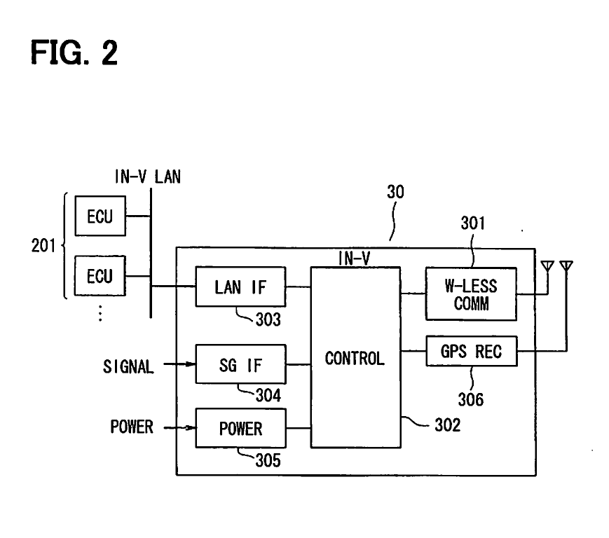

The in-vehicle apparatus 30 is provided as a wireless communication apparatus having a position detecting function; the wireless communication apparatus may be called DCM (Data Communication Module). With reference to FIG. 2, the in-vehicle apparatus 30 includes: a wireless communication controller 301; a control circuit 302 containing a CPU and memory; an in-vehicle LAN interface portion 303 which communicates with an engine start ECU 201 (engine start apparatus) such as a power source ECU and an engine control ECU, via an in-vehicle LAN (Local Area Network); a vehicle signal interface portion 304 which receives the various vehicle signals; a power source portion 305 which provides an operation power from a vehicle power source; and a GPS receiver 306 which communicates with GPS satellites. The wireless communication controller 301 communicates with the wireless communication network 50 via wireless communication.

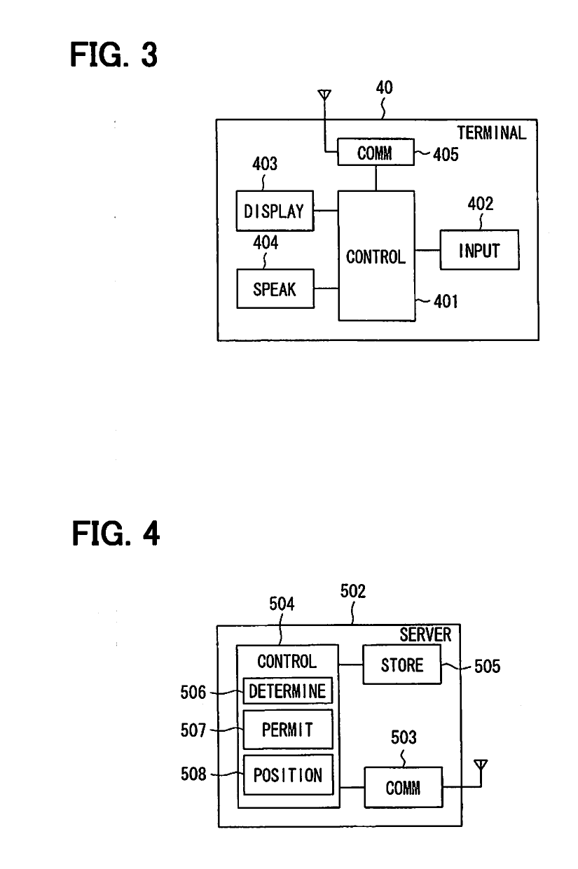

The terminal 40 is provided as a portable terminal carried by a user, such as a cellular phone and a smart phone. With reference to FIG. 3, the terminal 40 includes: a control circuit 401, a manipulation input portion 402, a display portion 403 (notification device or means), a sound output portion 404 (notification device or means, or speaker), and a communication portion 405. The control circuit 401 includes a CPU. The manipulation input portion 402 includes a push-button switch and a touch switch on the display portion 403. Moreover, the communication portion 405 communicates with the wireless communication network 50. The terminal 40 stores an application software program for a vehicular remote start. When a user activates the application software program and then performs a specific manipulation (i.e., an input manipulation for start request), a start request instruction or command is transmitted to the wireless communication network 50.

The wireless communication network 50 includes a server 502 and multiple wireless communication base stations 501, which are located separate from vehicles. The wireless communication base stations 501 may be also referred to a wireless base station 501. The server 502 is disposed in a communication center. With reference to FIG. 4, the server 502 includes: a communication portion 503 which communicates with the communication base stations 501 via a wireless link or a wired link; a control circuit 504; and a storage portion 505 which stores communication areas and installation regions of communication base stations 501. Furthermore, this server 502 can specify or identify a location and communications area of a subject communication base station 501 with which the terminal 40 or in-vehicle apparatus 30 performs direct wireless communication. The server 502 can determine whether a subject region or area is an idling prohibition ordinance-legislated region from the communication area or position related information (for example, a location, a base station number, base station cell information, latitude/longitude information) of the subject communication base station 501. The control circuit 504 includes a CPU and memory, and functions as a determination section, device, or means 506, a start permission output section, device, or means 507, and a host-vehicle position estimation section, device, or means 508 by executing software programs. The wireless communication network 50 includes, for example, a public telephone switching network, a digital communication network (ISDN), the Internet, a wired link such as an optical fiber link, or a cellular phone network, a PHS (Personal Handy-phone System) network, and a wireless LAN network.

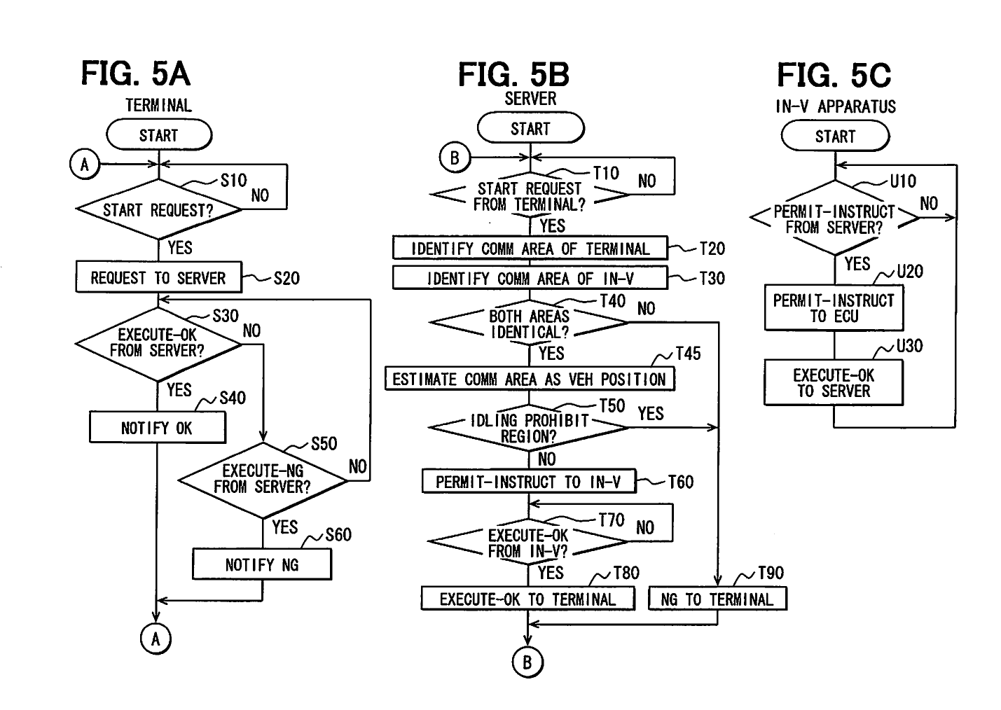

The following will explain operations of control circuits 401, 504, and 302 of the terminal 40, the server 502, and the in-vehicle apparatus 30 of the vehicular remote start system 10 with reference to FIGS. 5A, 5B, and 5C, respectively.

It is further noted that a flowchart in the present application includes sections (also referred to as steps), which are represented, for instance, as S10, T10, U10, V10, W10, P10, Q10, and R10. Further, each section can be divided into several sections while several sections can be combined into a single section. Furthermore, each of thus configured sections can be referred to as a module, device, or means and achieved not only (i) as a software section in combination with a hardware unit (e.g., computer), but also (ii) as a hardware section, including or not including a function of a related apparatus. Further, the hardware section may be inside of a microcomputer.

Now, a user performs a specific manipulation to the terminal 40. The terminal determines that a start request command arises (S10 in FIG. 5A). The terminal 40 transmits a start request command to the server 502 (S20).

As indicated at T10 in FIG. 5B, the server 502 stands by or waits for the start request command that is transmitted from the terminal 40. Upon receiving the start request command from the terminal 40, the server 502 identifies a first subject communication base station 501A (in FIG. 1) at T20; the first subject communication base station 501 performs direct wireless communication with the terminal 40, among the multiple communication base stations 501. The server 502 then obtains a first communication area of the first subject communication base station 501A. At T30, the server 502 identifies a second subject communication base station 501B (in FIG. 1); the second subject communication base station 501B performs direct wireless communication with the in-vehicle apparatus 30 having one-to-one correspondence with the terminal 40. The server 502 then obtains a second communication area of the second subject communication base station 501B.

Furthermore, at T40, the server 502 determines whether the first communication area of the first subject communication base station 501A and the second communication area of the second subject communication base station 501B are identical to each other. If the two communication areas are identical, at 145, the server 502 estimates, as a host-vehicle position, the first communication area being identical to the second communication area. Thus, the control circuit 504 of the server 502 may function as or include a host-vehicle position estimation section, device, or means 508. Then, at T50, the server 502 determines whether the first communications area (i.e., the host-vehicle position) is included in an idling prohibition ordinance-legislated region. When it is not included in the idling prohibition ordinance-legislated region, a start permission command is transmitted to the in-vehicle apparatus 30 at T60. Thus, the control circuit 504 of the server 502 may function as or include a determination section, device, or means 506. The control circuit 504 of the server 502 may function as or include a start permission output section, device, or means 507.

With reference to U10 in FIG. 5C, the in-vehicle apparatus 30 is in a state of standing by or waiting for a start permission command transmitted from the server 502. When the start permission command is transmitted from the server 502, the flow advances to U20. At U20, the start permission command is transmitted or outputted to the engine start ECU 201 in the host vehicle via the LAN interface portion 303. This permits a remote start of the engine which serves as a power apparatus of the host vehicle 20. At U30, the in-vehicle apparatus 30 transmits information “execution OK” indicative of a completion of the remote start to the server 502.

Then, when the server 502 receives the information “execution OK” from the in-vehicle apparatus 30 (T70: YES), At 180, the information “execution OK” is transmitted to the terminal 40. It is noted that the server 502 may determine that the first communication area of the first subject communication base station 501A and the second communication area of the second subject communication base station 501B are not identical (T40: No), or the server 502 may determine that the host-vehicle position is included in the idling prohibition ordinance-legislated region (T50: Yes). In such a case, any start permission command is not outputted. The flow then advances to T90, where information “execution NG” indicating that a remote start is unexecuted is transmitted to the terminal 40.

When the terminal 40 receives the information “execution OK” from the server 502 (T30: Yes), a message or information indicative of “execution completion” is notified via the display portion 403 and the sound output portion 404 at S40. When the terminal 40 receives the information “execution NG” from the server 502 (S50: Yes), a message or information, which indicates that any remote start is unexecuted because the host-vehicle position is in the idling prohibition region, is notified or outputted via the display portion 403 and the sound output portion 404.

Thus, the above first embodiment is provided as follows. When the user performs an input manipulation for a start request using the terminal 40, the host-vehicle position estimation section 508 of the server 502 estimates a host-vehicle position (T45). The determination section 506 determines whether the host vehicle 20 exists in an idling prohibition ordinance-legislated region (T50). When it is determined that the host vehicle 20 does not exist in the idling prohibition ordinance-legislated region by the determination section 506, the start permission output section 507 in the server 502 outputs the start permission command to the engine start ECU 201 of the host vehicle 20 (T60). When it is determined that the host vehicle 20 exists in the idling prohibition ordinance-legislated region, the start permission output section 507 in the server 502 does not output any start permission command. According to this configuration, whether the host-vehicle position is in the idling prohibition ordinance-legislated region may be automatically detected. When the host vehicle or the host-vehicle position is in the idling prohibition ordinance-legislated region, an engine remote start can be prevented.

Moreover, the first embodiment is further provided as follows. The first subject communication base station 501A performs direct wireless communication with the terminal 40 among the plurality of communication base stations 501; the second subject communication base station 501B performs direct wireless communication with the in-vehicle apparatus 30 among the plurality of communication base stations 501. The host-vehicle position estimation section 508 determines whether the first communication area of the first subject communication base station 501A is the same as the second communication area of the second subject communication base station 501B. When both the communication areas are the same, the same communication area is estimated or determined as the host-vehicle position. This configuration permits the server 502 to determine whether the host vehicle 20 exists in the idling prohibition ordinance-legislated region based on the communications areas of the communication base stations 501, thereby determining whether the in-vehicle apparatus 30 exists in the idling prohibition ordinance-legislated region, without using any car navigation apparatus (i.e., navigation ECU). Such a car navigation apparatus includes a host-vehicle position detection portion such as a GPS receiver; a storage portion which stores map data; and a control circuit for route retrieval. When the map data contains previously idling prohibition ordinance-legislated regions, the car navigation apparatus itself may determine whether a host vehicle exists in an idling prohibition ordinance-legislated region. However, if the car navigation apparatus is necessary, an in-vehicle apparatus may be large-scale or more complicated. In contrast, the first embodiment determines whether to be in an idling prohibition ordinance-legislated region, using the wireless communication network 50 which permits data communication between the terminal 40 and the in-vehicle apparatus 30; therefore, any car navigation apparatus may be unnecessary.

### Second Embodiment

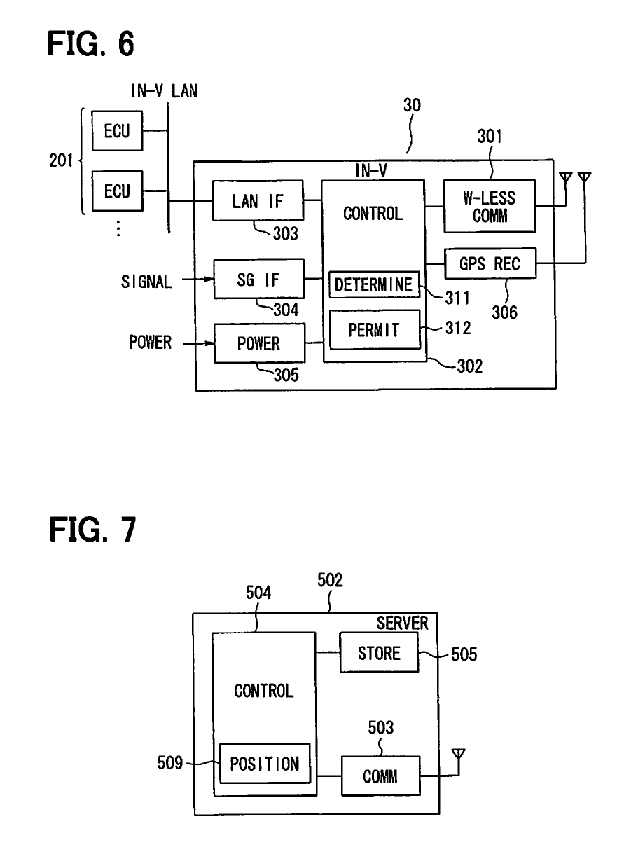

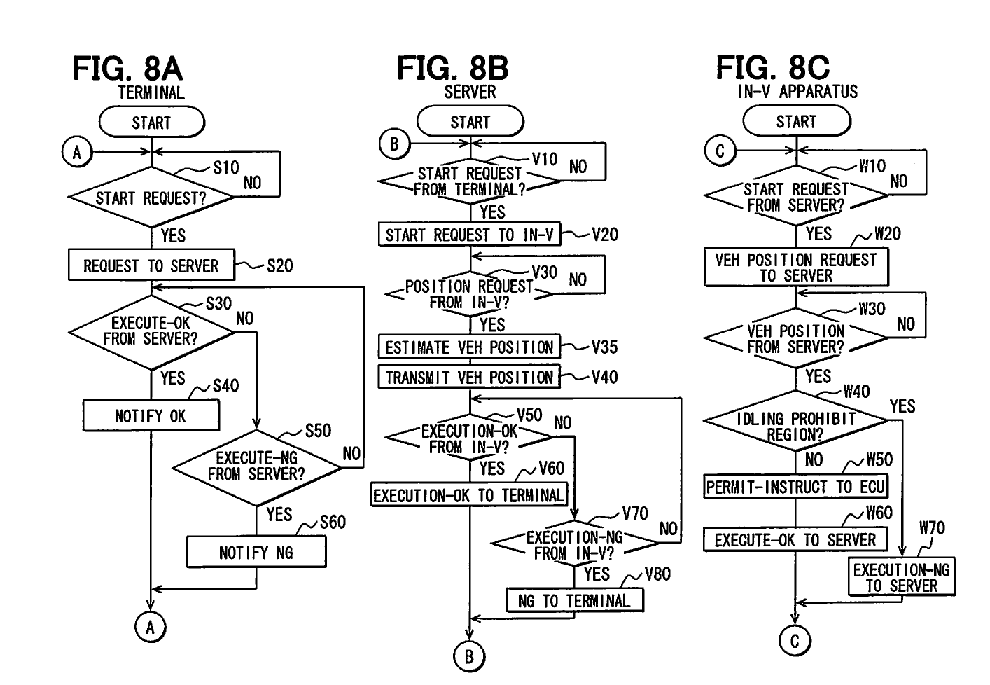

The following will explain a second embodiment with reference to FIG. 6 to FIG. 8C. The second embodiment is different from the first embodiment in that: (i) the in-vehicle apparatus 30 includes a determination section 311 and a start permission output section 312; (ii) the server 502 does not include the determination section 506 and the start permission output section 507; and (iii) the server 502 includes a host-vehicle position estimation section 509 different from the host-vehicle position estimation section 508. The control process of the terminal 40 in the second embodiment is identical to that of the first embodiment. In order to help the understanding, FIG. 8A identical to FIG. 5A is illustrated.

When the server 502 receives a start request from the terminal 40 (V10: Yes), the server 502 transmits a start request to the in-vehicle apparatus 30 (V20). When the in-vehicle apparatus 30 receives the start request from the server 502 (W10: Yes), the in-vehicle apparatus 30 transmits a request of providing the host-vehicle position information on the host vehicle 20 to the server 502 (W20). Alternatively, the in-vehicle apparatus 30 may use the host-vehicle position information that is periodically transmitted and updated by the server 502. When the server 502 receives the request of providing the host-vehicle position information from the in-vehicle apparatus 30 (V30: Yes), the server 502 estimates a host-vehicle position (V35). Thus, the control circuit 504 of the server 502 may function as or include a host-vehicle position estimation section, device, or means 509. In such a case, the server 502 estimates the host-vehicle position based on the location or information on latitude and longitude of a subject communication base station 501 which performs the direct wireless communication with the in-vehicle apparatus 30. However, the host-vehicle position estimation section 508 of the first embodiment may be used to replace the host-vehicle position estimation section 509 of the second embodiment. Then, the information on the host-vehicle position is transmitted to the in-vehicle apparatus 30 (V40).

The in-vehicle apparatus 30, which received the above information on the host-vehicle position (W30: Yes), determines whether the host-vehicle position exists in an idling prohibition ordinance-legislated region from the information on the host-vehicle position (W40). Thus, the control circuit 302 of the in-vehicle apparatus 30 may function as or include a determination section, device, or means 311. In this case, the in-vehicle apparatus 30 may store previously the idling prohibition ordinance-legislated regions, or receive the information on the idling prohibition ordinance-legislated regions from the server 502 as needed. When it is determined that the host vehicle 20 does not exist in an idling prohibition ordinance-legislated region, the in-vehicle apparatus 30 outputs a start permission instruction to the engine start ECU 201 of the host vehicle 20 (W50). Thus, the control circuit 302 of the in-vehicle apparatus 30 may function as or include a start permission output section, device, or means 312. This permits a remote start of the engine etc. Then, the in-vehicle apparatus 30 transmits information “execution OK” indicating that the remote start is executed to the server 502. Moreover, when the host vehicle 20 is not in an idling prohibition ordinance-legislated region (W40: No), the in-vehicle apparatus 30 transmits the information “execution NG” indicating that a remote start is unexecuted to the server 502.

When the server 502 receives the information “execution OK” from the in-vehicle apparatus 30 (V50: Yes), the server 502 transmits the information “execution OK” to the terminal 40 (V60). Moreover, when the server 502 receives the information “execution NG” from the in-vehicle apparatus 30 (V70: Yes), the server 502 transmits the information “execution NG” to the terminal 40 (V80).

According to the second embodiment, the in-vehicle apparatus 30 can determine whether the host vehicle 20 exists in an idling prohibition ordinance-legislated region. Moreover, the host-vehicle position estimation section 509 of the server 502 estimates the host-vehicle position based on the location or information on latitude and longitude of the subject communication base station 501 which performs the direct wireless communication with the in-vehicle apparatus 30. This configuration may permit a simple estimation of the host-vehicle position.

### Third Embodiment

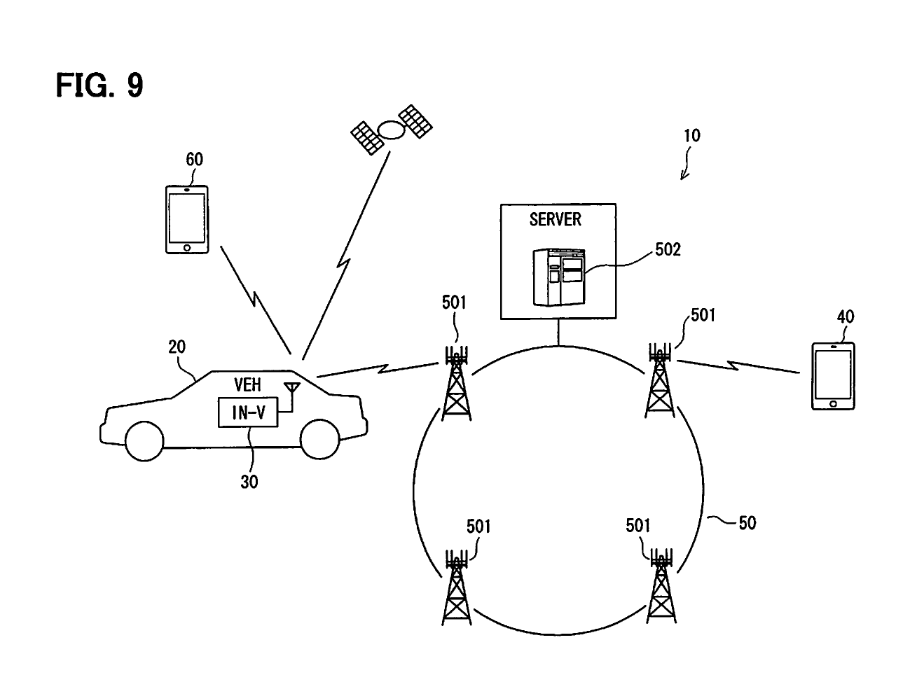

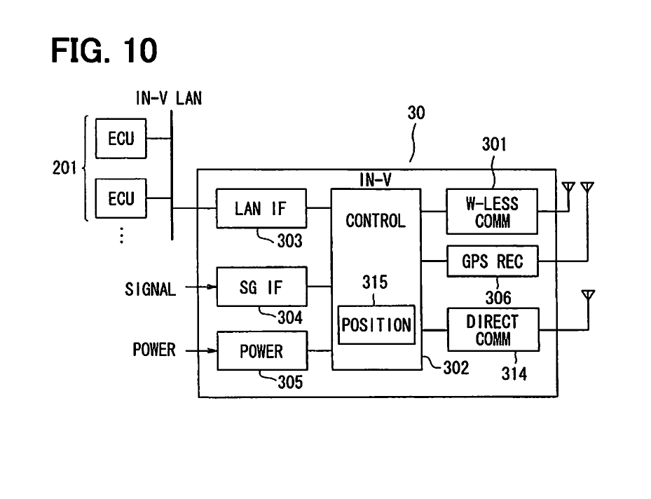

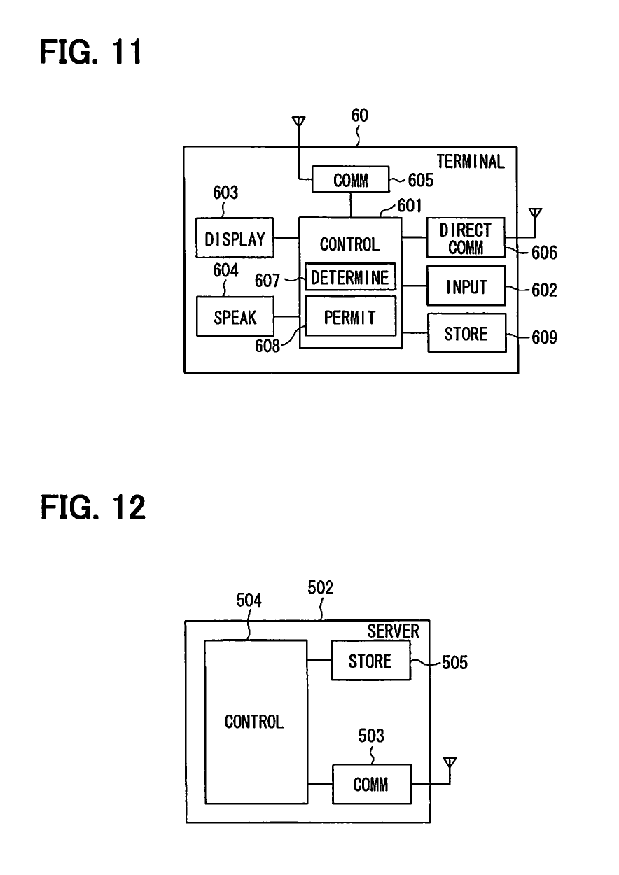

The following will explain a third embodiment with reference to FIG. 9 to FIG. 13C. With reference to FIG. 11, a portable terminal 60 includes a control circuit 601, a manipulation input portion 602, a display portion 603, a sound output portion 604 (i.e., speaker), and a communication portion 605, which are identical to the control circuit 401, the manipulation input portion 402, the display portion 403, the sound output portion 404, and the communication portion 405 of the terminal 40. The portable terminal 60 further includes a direct wireless communication portion 606 (direct communication device or means) that performs direct wireless communication with the in-vehicle apparatus 30, such as Wi-Fi (registered trademark) wireless communication system. The control circuit 601 of the portable terminal 60 may function as or include a determination section, device, or means 607 and a start permission output section, device, or means 608 by executing software programs. Furthermore, this portable terminal 60 includes a storage portion 609 which stores idling prohibition ordinance-legislated regions. Alternatively, the portable terminal 60 may receive the information on idling prohibition ordinance-legislated regions from the server 502 as needed.

The in-vehicle apparatus 30 includes a direct wireless communication portion, device, or means 314 that performs direct wireless communication with the portable terminal 60. Moreover, the control circuit 302 of the in-vehicle apparatus 30 includes a host-vehicle position estimation section, device, or means 315. This host-vehicle position estimation section 315 estimates the host-vehicle position based on GPS signals acquired by the GPS receiver 306. Alternatively, the in-vehicle apparatus 30 may receive the information on the host-vehicle position from the server 502 as needed, like the first embodiment and the second embodiment.

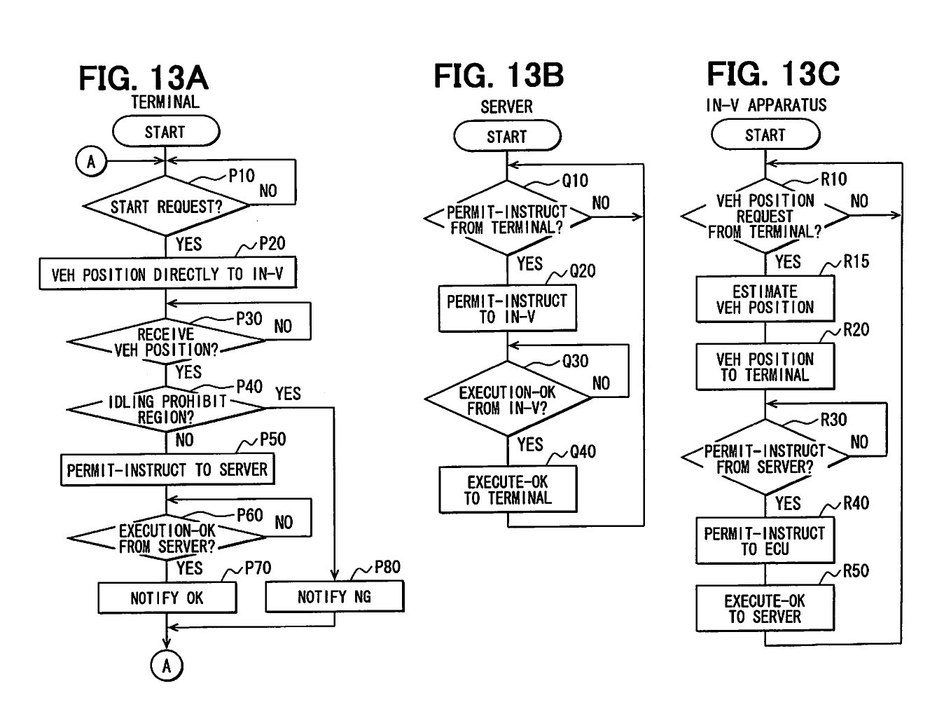

Now, refer to FIGS. 13A, 13B, and 13C. When the portable terminal 60 receives a start request (P10: Yes), the portable terminal 60 performs direct wireless communication with the in-vehicle apparatus 30 and transmits a request of the host-vehicle position information, which can be acquired by the in-vehicle apparatus 30, to the in-vehicle apparatus 30 (P20). This host-vehicle position information signifies vehicle position information acquired from the GPS signal of the GPS receiver 306 in the the in-vehicle apparatus 30, or the information on the host-vehicle position received from the server 502. When the in-vehicle apparatus 30 receives the request of the host-vehicle position information from the portable terminal 60 (R10: Yes), the in-vehicle apparatus 30 estimates the host-vehicle position (R15) and transmits the host-vehicle position to the portable terminal 60 (R20). Thus, the control circuit 302 of the in-vehicle apparatus 30 may function as or include a host-vehicle position estimation section, device, or means 315.

When the portable terminal 60 receives the above host-vehicle position information (P30: Yes), the portable terminal 60 determines whether the host-vehicle position information corresponds to an idling prohibition ordinance-legislated region (P40) based on the idling prohibition ordinance-legislated region information previously stored in the portable terminal 60. Thus, the control circuit 601 of the portable terminal 60 may function as or include a determination section, device, or means 607. The portable terminal 60 may receive the information on the idling prohibition ordinance-legislated regions as needed from the server 502. Then, when it does not correspond to the idling prohibition ordinance-legislated region, the portable terminal 60 transmits a starting permission command to the server 502 (P50). Thus, the control circuit 601 of the portable terminal 60 may function as or include a start permission output section, device, or means 608. Moreover, when the host-vehicle position information corresponds to the idling prohibition ordinance-legislated region (P40: YES), the start permission command is not outputted. The display portion 403 and the sound output portion 404 are controlled to output information “execution NG” indicating that a remote start is unexecuted (P80).

When the server 502 receives the start permission command from the portable terminal 60 (Q10: Yes), the server 502 transmits the start permission command to the in-vehicle apparatus 30 (Q20). When the in-vehicle apparatus 30 receives the start permission command from the server 502 (R30: Yes), the in-vehicle apparatus 30 outputs the start permission command to thereby drive the engine start ECU (R40). Then, the in-vehicle apparatus 30 transmits the information “execution OK” to the server 502 (R50).

When the server 502 receives the information “execution OK” from the in-vehicle apparatus 30 (Q30: Yes), the server 502 transmits the information “execution OK” to the portable terminal 60 (Q40). Then, when the portable terminal 60 receives the information “execution OK” from the server 502 (P60: Yes), the portable terminal 60 controls the display portion 603 and the sound output portion 604 to output the information “execution OK” (P70).

In the third embodiment, while the portable terminal 60 performs the wireless communication with the in-vehicle apparatus 30 via the wireless communication network 50, the portable terminal 60 can perform the direct wireless communication with the in-vehicle apparatus 30 via the direct communication portions 606 and 314, without using any communication base stations 501. Thus, the portable terminal 60 acquires the host-vehicle position information from the in-vehicle apparatus 30 via the direct wireless communication, and determines whether the host vehicle 20 exists in an idling prohibition ordinance-legislated region based on the host-vehicle position information. This configuration permits a prompt determination as to whether the host vehicle 20 exists in an idling prohibition ordinance-legislated region based on the host-vehicle position information. Further, when it is determined that the host vehicle 20 exists in the idling prohibition ordinance-legislated region, the information indicating that a remote start is unexecuted is notified in the portable terminal 60 without passing through the wireless communication network 50. This permits a prompt notification indicating that a remote start is unexecuted to the user.

Further, in the above third embodiment, although the GPS signal is used as the host-vehicle position information, any navigation apparatus (navigation ECU) is not used. Thus, without using any car navigation apparatus, it may be determined whether a host vehicle 20 exists in an idling prohibition ordinance-legislated region. Further, the host-vehicle position information may be acquired from the server 502 in the third embodiment.

### Fourth Embodiment

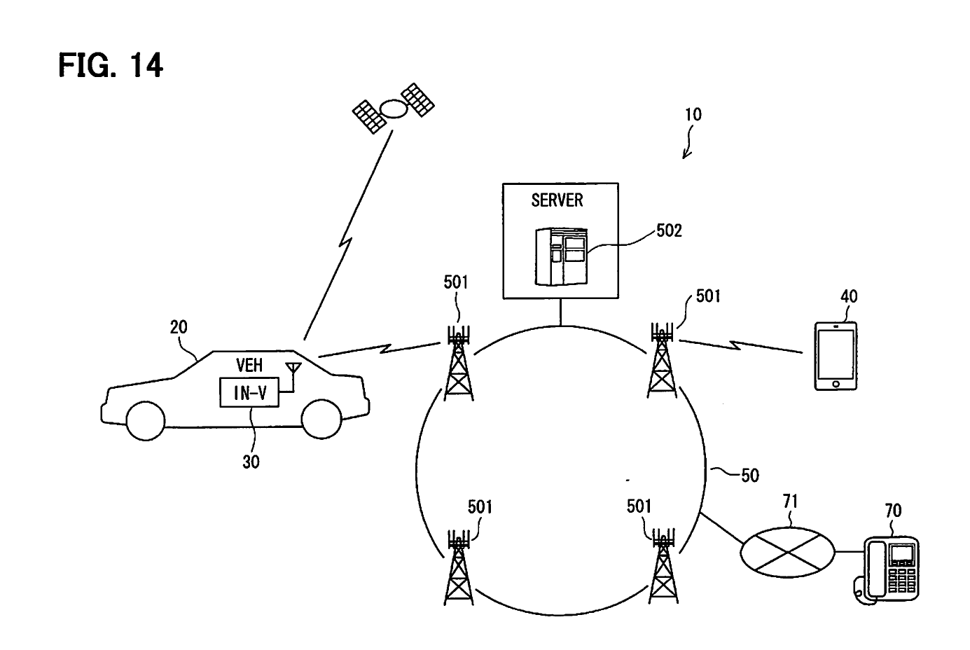

A fourth embodiment is illustrated in FIG. 14. The fourth embodiment is different from the first embodiment in that the system includes a fixed phone serving as a fixed terminal 70. The fixed terminal 70 can communicate with the wireless communication network 50 via a fixed phone network 71. In the fixed terminal 70, an input manipulation for engine start request is made (for example, a specific input manipulation in line with a predetermined guidance). Thereby, the vehicular remote start system 10 operates like the first embodiment basically. It is noted that the fixed terminal signifies a terminal that communicates via a fixed phone network, such as a main phone of a fixed phone and a wireless cordless handset of the fixed phone.

In this case, the host-vehicle position estimation section may estimate, as a host-vehicle position, an area designated by a long-distance number of a phone number of the fixed terminal 70.

### Fifth Embodiment

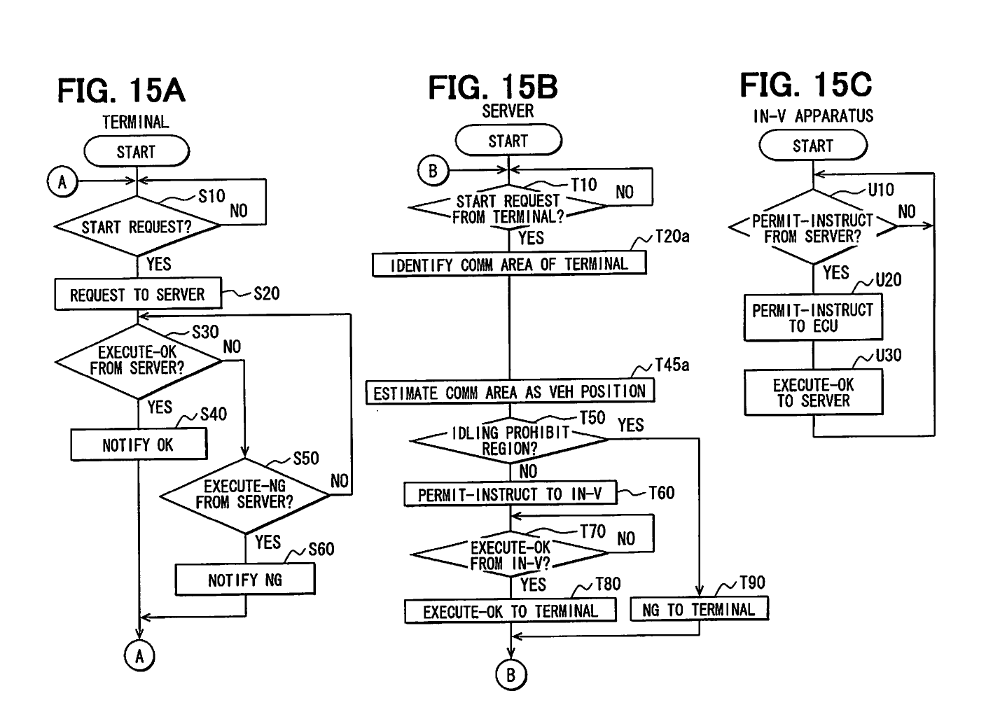

Furthermore, the host-vehicle position estimation section 508 of the first embodiment may be changed to that of a fifth embodiment as shown in FIGS. 15A, 15B, and 15C. That is, at T20a, the server 502 identifies a subject communication base station 501 which performs the direct wireless communication with the terminal 40. At T45a, the region designated by the communications area of this identified subject communication base station 501 is determined to be the host-vehicle position. Thus, the control circuit 504 of the server 502 may function as or include a host-vehicle position estimation section, device, or means 508.

### Sixth Embodiment

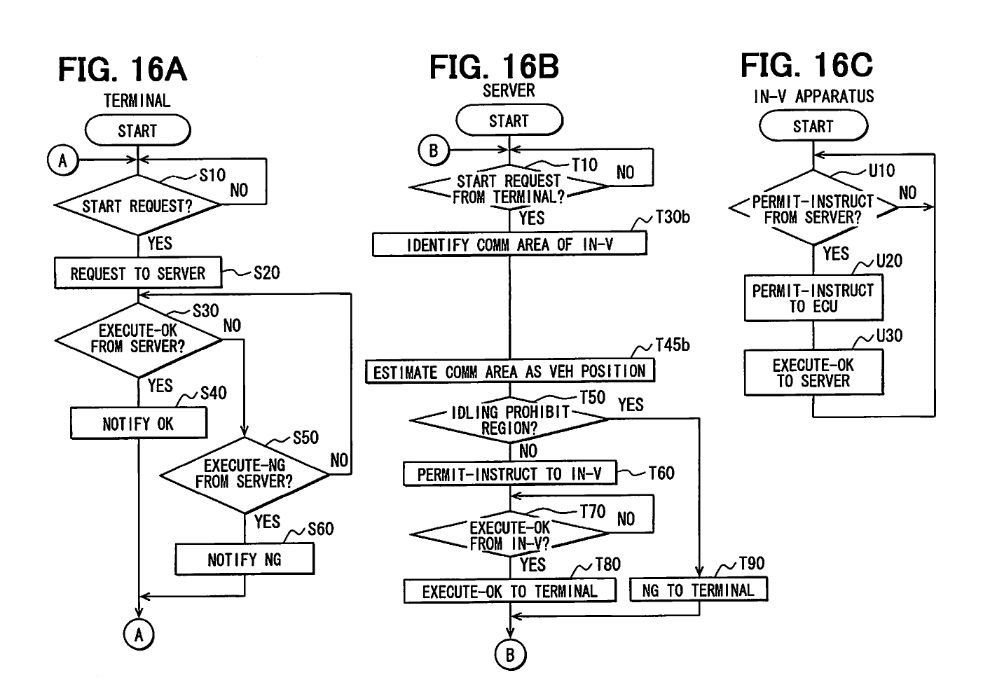

Furthermore, the host-vehicle position estimation section 508 of the first embodiment may be changed to that of a sixth embodiment as shown in FIGS. 16A, 16B, and 16C. That is, at T30b, the server 502 identifies a subject communication base station 501 which performs the direct wireless communication with the in-vehicle apparatus 30. At T45b, the region designated by the communications area of this identified subject communication base station 501 is determined to be the host-vehicle position. Thus, the control circuit 504 of the server 502 may function as or include a host-vehicle position estimation section, device, or means 508, similarly. Moreover, when the in-vehicle apparatus 30 includes a host-vehicle position estimation section, device, or means 315, the host-vehicle position estimation section 315 may estimate a host-vehicle position based on the position related information from a subject communication base station 501 which directly communicates with the in-vehicle apparatus 30.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A vehicular remote start system comprising:
an in-vehicle apparatus disposed in a host vehicle including an engine start apparatus that relates to an engine start of the host vehicle;
a terminal that receives an input manipulation of an engine start request by a user to request of the engine start;
a wireless communication network, which includes a server and a plurality of wireless base stations, to permit a communication between the in-vehicle apparatus and the terminal;
a host-vehicle position estimation section that estimates a host-vehicle position of the host vehicle;
a determination section that determines whether the host vehicle exists in an idling prohibition region, which is stipulated in a local governmental regulation, from the host-vehicle position estimated by the host-vehicle position estimation section upon receiving the engine start request in the terminal; and
a start permission output section that outputs a start permission instruction to the engine start apparatus when it is determined that the host vehicle does not exist in the idling prohibition region, and does not output the start permission instruction when it is determined that the host vehicle exists in the idling prohibition region.

2. The vehicular remote start system according to claim 1, wherein:
the determination section and the start permission output section are disposed in the server.

3. The vehicular remote start system according to claim 1, wherein:
the determination section and the start permission output section are disposed in the in-vehicle apparatus.

4. The vehicular remote start system according to claim 1, wherein:
the terminal and the in-vehicle apparatus communicate with each other via direct wireless communication portions as well as the wireless communication network;
the determination section and the start permission output section are disposed in the terminal;
the host-vehicle position estimation section is disposed in the in-vehicle apparatus;
the terminal transmits the engine start request to the in-vehicle apparatus via the direct wireless communication portion;
the determination section of the terminal determines whether the host vehicle exists in the idling prohibition region upon receiving the host-vehicle position estimated by the host-vehicle position estimation section in the in-vehicle apparatus via the direct wireless communication portion following transmitting the engine start request to the in-vehicle apparatus via the direct wireless communication portion; and
the start permission output section of the terminal does not output the start permission instruction when the determination section determines that the host vehicle exists in the idling prohibition region, and transmits the start permission instruction to the in-vehicle apparatus via the wireless communication network when the determination section determines that the host vehicle does not exist in the idling prohibition region.

5. The vehicular remote start system according to claim 1, wherein:
the host-vehicle position estimation section is disposed in the server;
a first communication area is of a first subject wireless base station, which is performing a direct wireless communication with the terminal, among the plurality of wireless base stations, whereas a second communication area is of a second subject wireless base station, which is performing a direct wireless communication with the in-vehicle apparatus, among the plurality of wireless base stations;
the host-vehicle position estimation section of the server estimates a subject communication area as the host-vehicle position,
(i) the subject communication area being one of the first communication area and the second communication area, or
(ii) the subject communication area being the first communication area identical to the second communication area when it is determined that the first communication area is identical to the second communication area.

6. The vehicular remote start system according to claim 1, wherein:
the host-vehicle position estimation section is disposed in the in-vehicle apparatus and estimates the host-vehicle position from GPS signals.

7. The vehicular remote start system according to claim 1, wherein:
the host-vehicle position estimation section is disposed in the in-vehicle apparatus, and estimates the host-vehicle position based on position related information acquired from a subject wireless base station, which is performing a direct wireless communication with the in-vehicle apparatus among the plurality of wireless base stations.

8. The vehicular remote start system according to claim 1, wherein:
the terminal includes a portable terminal.

9. The vehicular remote start system according to claim 1, wherein:
the terminal includes a fixed terminal.

10. The vehicular remote start system according to claim 1, wherein:
the terminal is a fixed phone as a fixed terminal; and
the host-vehicle position estimation section estimates, as the host-vehicle position, a region designated by a long-distance number of a phone number of the fixed phone that receives the input manipulation of the engine start request by the user.

11. The vehicular remote start system according to claim 1, wherein:
the host-vehicle position estimation section is disposed in the server;
a first communication area is of a first subject wireless base station, which is performing a direct wireless communication with the terminal, among the plurality of wireless base stations, whereas a second communication area is of a second subject wireless base station, which is performing a direct wireless communication with the in-vehicle apparatus, among the plurality of wireless base stations; and
the host-vehicle position estimation section of the server estimates, as the host-vehicle position, one of the first communication area and the second communication area.

12. The vehicular remote start system according to claim 1, wherein:
the host-vehicle position estimation section is disposed in the server;
a first communication area is of a first subject wireless base station, which is performing a direct wireless communication with the terminal, among the plurality of wireless base stations, whereas a second communication area is of a second subject wireless base station, which is performing a direct wireless communication with the in-vehicle apparatus, among the plurality of wireless base stations;
the host-vehicle position estimation section of the server performs a determination as to whether the first communication area and the second communication area are identical to each other; and
the host-vehicle position estimation section estimates, as the host-vehicle position, the first communication area being identical to the second communication area when the first communication area and the second communication area are identical to each other.
